(19) United States
(12) Patent Application Publication
(10) Pub. No.: US 2025/0264409 A1
(43) Pub. Date: Aug. 21, 2025

(54) SCANNING METHOD, SCANNING SYSTEM, AND POSITION INFORMATION ACQUISITION METHOD

(71) Applicant: CANON KABUSHIKI KAISHA, Tokyo (JP)

(72) Inventors: RYOTA OTSUBO, Tokyo (JP); YUKIO FURUKAWA, Kanagawa (JP)

(21) Appl. No.: 19/200,450

(22) Filed: May 6, 2025

Related U.S. Application Data
(63) Continuation of application No. PCT/JP2023/040361, filed on Nov. 9, 2023.

(30) Foreign Application Priority Data
Nov. 10, 2022 (JP) 2022-180542
Oct. 31, 2023 (JP) 2023-186775

(51) Int. Cl. G01N 21/64

(52) U.S. Cl. CPC G01N 21/6428; G01N 2021/6439; G01N 2201/105

(57) ABSTRACT

A scanning method for optically scanning an array plate including a plurality of spots on its front surface includes an interface-forming step of forming at least one of a solid-gas interface and a solid-solid interface in a first region of the front surface of the plate by bringing a gas or a solid into contact with the first region and forming a solid-liquid interface in a second region of the front surface of the plate by bringing a liquid into contact with the second region where the plurality of spots is included, a step of optically acquiring first position information about an interface position of at least one of the solid-gas interface and the solid-solid interface, and a step of acquiring second position information about an interface position of the solid-liquid interface based on the first position information.

### CROSS-REFERENCE TO RELATED APPLICATIONS

This application is a Continuation of International Patent Application No. PCT/JP2023/040361, filed Nov. 9, 2023, which claims the benefit of Japanese Patent Applications No. 2022-180542, filed Nov. 10, 2022, and No. 2023-186775, filed Oct. 31, 2023, all of which are hereby incorporated by reference herein in their entirety.

### BACKGROUND OF THE INVENTION

### Field of the Invention

The present invention relates to a scanning method for optically scanning an array plate, a scanning system, and a position information acquisition method.

### Background Art

Array plates in which various substances, such as proteins, peptides, and nucleic acids, are immobilized in a spot pattern on a substrate are known. By using an array plate, the interactions between various immobilized substances and substances in a specimen can be observed simultaneously. This enables a comprehensive analysis of interactions with various substances, including biological specimens such as blood, cell extracts, saliva, and interstitial fluid.

As a method for measuring a specimen, selectively fluorescently labeling spots where an interaction of interest has occurred to obtain optical information is known. As an apparatus for observing a fluorescently labeled specimen, for example, a confocal laser microscope is known.

Patent Document 1 discusses a confocal microscope apparatus configured to align a back or front surface of a cover glass holding a specimen with a focusing position as a reference based on reflected light from the back or front surface of the cover glass.

Further, Patent Document 2 discusses a confocal scanning optical microscope that includes a polarizing beam splitter and a λ/4 plate.

### CITATION LIST

### Patent Literature

PTL 1: Japanese Patent Laid-Open No. 2009-53578
PTL 2: Japanese Patent Laid-Open No. 6-214162

When optically scanning an array plate, it is necessary to identify the position of its front surface (surface where spots exist) and focus light on it. As discussed in Patent Document 1, there is a method for optically detecting the position of a front surface of an array plate based on reflected light from the front surface.

However, there may be a case where the front surface of the array plate is brought into contact with a liquid referred to as an observation liquid. In a case where the front surface of the array plate is brought into contact with the observation liquid as described above, the refractive index difference at the solid-liquid interface (substrate/observation liquid interface) is small, and reflection is less likely to occur at the interface, making it difficult to optically detect the position of the front surface of the array plate. For example, in a case where the substrate is glass and the observation liquid is a glycerol solution with a refractive index close to that of the glass, the refractive index difference at the solid-liquid interface is significantly small, and it is difficult to optically detect the position of the front surface of the array plate.

Patent Documents 1 and 2 do not identify the position of the front surface of the array plate to ensure accurate scanning when the front surface of the array plate is brought into contact with the liquid.

### SUMMARY OF THE INVENTION

The present invention is in consideration of the above-described points and directed to enabling accurate scanning in a case where the front surface of the array plate is brought into contact with the liquid.

A scanning method according to an embodiment of the present invention is a scanning method for optically scanning an array plate including a plurality of spots on its front surface, the scanning method includes an interface-forming step of forming at least one of a solid-gas interface and a solid-solid interface in a first region of the front surface of the plate by bringing a gas or a solid into contact with the first region and forming a solid-liquid interface in a second region of the front surface of the plate by bringing a liquid into contact with the second region where the plurality of spots is included, a step of optically acquiring first position information about an interface position of at least one of the solid-gas interface and the solid-solid interface, and a step of acquiring second position information about an interface position of the solid-liquid interface based on the first position information.

Further, a scanning system according to an embodiment of the present invention is a scanning system for optically scanning an array plate including a plurality of spots on its front surface, the scanning system includes a support portion configured to support the array plate so that at least one of a solid-gas interface and a solid-solid interface is formed in a first region of the front surface of the plate by bringing a gas or a solid into contact with the first region and a solid-liquid interface is formed in a second region of the front surface of the plate by bringing a liquid into contact with the second region where the plurality of spots is included, an optical system configured to irradiate the spots with primary light and collect secondary light, a scanning unit configured to optically scan the array plate by changing a relative position between the array plate and the primary light, a first position information acquisition unit configured to optically acquire first position information about an interface position of at least one of the solid-gas interface and the solid-solid interface, and a second position information acquisition unit configured to acquire second position information about an interface position of the solid-liquid interface based on the first position information.

Yet further, a position information acquisition method according to an embodiment of the present invention, a position information acquisition method for acquiring information about a position of one surface of an array plate including a plurality of spots on the one surface in a state where at least a portion of the plurality of spots is in contact with a liquid, the position information acquisition method includes an interface-forming step of forming at least one of a solid-gas interface and a solid-solid interface in a first region of the one surface by bringing a gas or a solid into contact with the first region and forming a solid-liquid interface in a second region of the one surface by bringing a liquid into contact with the second region where the plurality of spots is included, a step of optically acquiring first position information about an interface position of at least one of the solid-gas interface and the solid-solid interface, and a step of acquiring second position information about an interface position of the solid-liquid interface based on the first position information.

Further features of the present invention will become apparent from the following description of exemplary embodiments with reference to the attached drawings.

### BRIEF DESCRIPTION OF THE DRAWINGS

FIG. 1 is a flowchart illustrating a procedure of a scanning method.

FIG. 2A is a plan view illustrating an example of an array plate.

FIG. 2B-1 is a diagram for describing an array plate divided into a first region and a second region.

FIG. 2B-2 is a diagram for describing an array plate divided into a first region and a second region.

FIG. 2B-3 is a diagram for describing an array plate divided into a first region and a second region.

FIG. 2B-4 is a diagram for describing an array plate divided into a first region and a second region.

FIG. 2B-5 is a diagram for describing an array plate divided into a first region and a second region.

FIG. 3A is a diagram illustrating a schematic configuration of a scanning system according to a first embodiment.

FIG. 3B is a diagram illustrating a schematic configuration of a scanning system according to the first embodiment.

FIG. 4A is a diagram for describing a process for acquiring first position information according to the first embodiment.

FIG. 4B is a diagram for describing a process for acquiring first position information according to the first embodiment.

FIG. 4C is a diagram for describing a process for acquiring first position information according to the first embodiment.

FIG. 5A is a diagram illustrating an example of a configuration of a one-dimensional scanning mechanism.

FIG. 5B is a diagram illustrating an example of a configuration of a one-dimensional scanning mechanism.

FIG. 6 is a diagram illustrating a schematic configuration of a modified example of a scanning system according to the first embodiment.

FIG. 7 is a diagram illustrating a schematic configuration of a modified example of a scanning system according to the first embodiment.

FIG. 8A is a diagram for describing a process for acquiring first position information according to a second embodiment.

FIG. 8B is a diagram for describing the process for acquiring first position information according to the second embodiment.

FIG. 8C is a diagram for describing the process for acquiring first position information according to the second embodiment.

FIG. 9A is a diagram for describing a process for acquiring first position information and third position information according to a third embodiment.

FIG. 9B is a diagram for describing a process for acquiring first position information and third position information according to the third embodiment.

FIG. 9C is a diagram for describing a process for acquiring first position information and third position information according to the third embodiment.

FIG. 10 is a diagram illustrating a schematic configuration of a scanning system according to a fourth embodiment.

FIG. 11 is a diagram illustrating a schematic configuration of a modified example of the scanning system according to the fourth embodiment.

FIG. 12A is a diagram illustrating a modified example of the first region of the array plate.

FIG. 12B is a diagram illustrating a modified example of the first region of the array plate.

FIG. 12C is a diagram illustrating a modified example of the first region of the array plate.

### DESCRIPTION OF THE EMBODIMENTS

Preferred embodiments of the present invention will be described below with reference to the attached drawings.

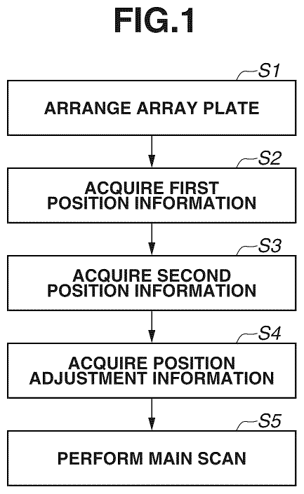

First, an overview of a scanning method to which the present invention is applied will be described below with reference to FIGS. 1, 2A, and 2B-1 to 2B-5.

### [Array Plate]

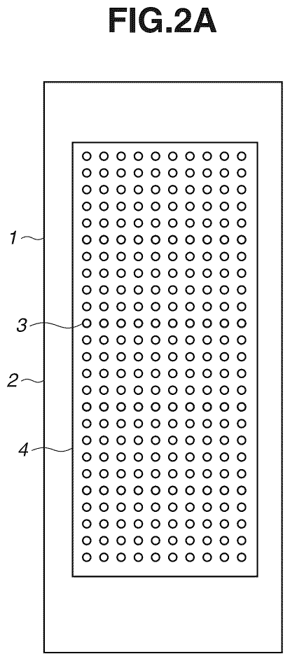

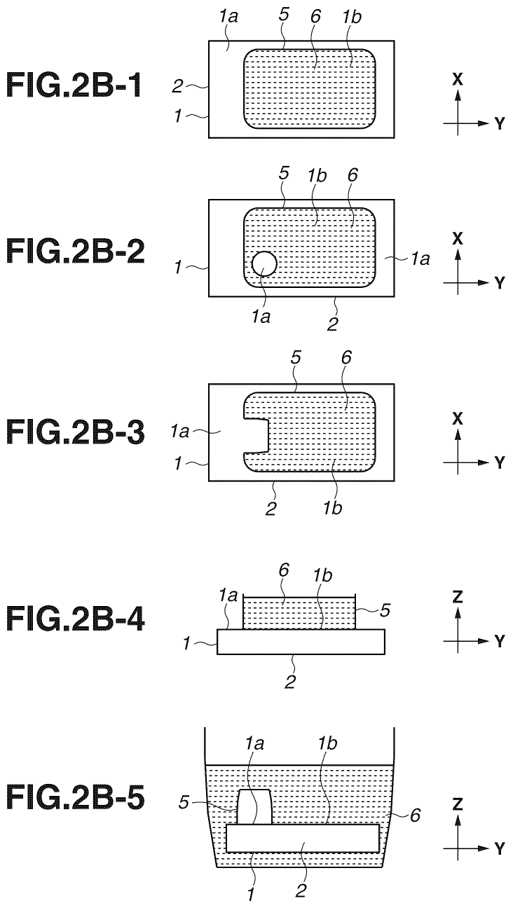

FIG. 2A is a plan view illustrating an example of an array plate 1. A plurality of spots 3 aligned both vertically and horizontally is located in a region 4 on a surface of a substrate 2, such as a slide glass, of the array plate 1. A biomolecule containing a peptide bond is immobilized at each spot 3. A single type of biomolecule is immobilized at each spot 3. Array plates are also referred to as microarrays (microchips), protein arrays (protein chips), peptide arrays (protein chips), or DNA arrays (DNA chips).

As described above, the array plate 1 includes the spots 3 containing a plurality of types of biomolecules on the substrate 2 and is used for a comprehensive analysis of a specimen. For example, Agilent Technologies, Inc. and Ray Biotech, Inc. offer microarray plates, and commercially-available array plates can be used. Alternatively, array plates may be prepared. Immobilization of a biomolecule is also referred to as adsorption and includes immobilization through hydrophobic interactions, electrostatic interactions, van der Waals interactions, hydrogen bonding, and covalent bonding. The substrate 2 is preferably transparent. Examples of materials of the substrate 2 include glass, synthetic quartz, quartz, borosilicate glass. Examples of materials of the substrate 2 further include resins such as polystyrene, polypropylene, (meth)acrylic resin, polyamide, polyimide, melamine, acrylonitrile butadiene styrene (ABS), polyphenylene oxide urethane, silicone, epoxy, and polydimethylsiloxane.

### [Observation Liquid]

A plate surface (the front surface where the spots 3 are located, hereinafter, referred to simply as the front surface) of the array plate 1 may be brought into contact with a liquid referred to as an observation liquid. The observation liquid is also referred to as a purge liquid, as it replaces optical background noise components, that is, purges them. In acquiring optical information, the observation liquid is brought into contact with at least some of the spots 3 of the array plate 1. The observation liquid preferably exhibits good affinity for a liquid used in the array plate 1 in the immediately preceding process. Further, the observation liquid desirably has a refractive index comparable to that of the substrate 2 and prevents the oxidation of a substance, particularly a labeled substance, on the array plate 1. Further, the observation liquid preferably does not emit fluorescence upon irradiation with excitation light for optical information acquisition. While a glycerol solution is suitably used as a liquid that meets the above-described conditions, an appropriate liquid may be selected based on the properties of the labeled substance, the biomolecule, and/or the specimen. The observation liquid preferably contains at least one selected from the group consisting of glycerol, water, and Tris-Buffered Saline with Tween 20 (TBST).

### [Scanning Method]

In applying the present invention, the front surface of the array plate 1 (the substrate 2) is divided into a first region 1a, which is brought into contact with gas (air), and a second region 1b, which is brought into contact with a liquid (observation liquid) 6, as illustrated in FIGS. 2B-1 to 2B-5. The second region 1b is a region that includes the plurality of spots 3, and the first region 1a does not include a region that overlaps with the plurality of spots 3. While a specific example will be described below, a frame 5 for retaining liquid is placed on the array plate 1 to separate the first region 1a, which is brought into contact with air, and the second region 1b, where the observation liquid 6 is brought into contact with the spots 3. It should be noted that the illustration of the spots 3 is omitted in FIGS. 2B-1 to 2B-5. It should be noted that it is not necessary for all regions other than the second region 1b on the front surface of the array plate 1 to be the first region 1a, and only some of the regions other than the second region 1b may be the first region 1a.

FIG. 1 illustrates a scanning method procedure.

In step S1, the array plate 1 is arranged to bring air into contact with the first region 1a and bring the observation liquid 6 into contact with the second region 1b, thereby forming a solid-gas interface in the first region 1a and a solid-liquid interface in the second region 1b.

The arrangement of the array plate 1 will be described below with reference to FIGS. 2B-1 to 2B-5. A short side direction and a long side direction of the array plate 1 are respectively defined as a main scanning direction and a sub-scanning direction, and X, Y, and Z are respectively defined as the main scanning direction, the sub-scanning direction, and a direction perpendicular to an XY plane (plane including the main scanning direction and the sub-scanning direction of the array plate 1).

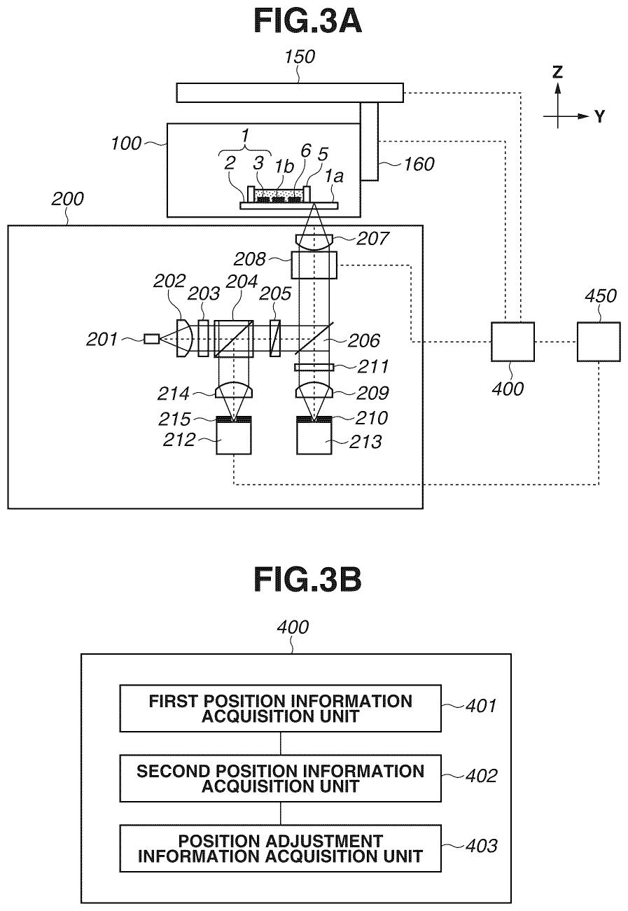

FIGS. 2B-1 to 2B-3 are plan views illustrating the array plate 1 (diagrams viewed from the front surface side in the Z-direction), and the first region 1a with the solid-gas interface (substrate/air interface) and the second region 1b with the solid-liquid interface (substrate/observation liquid interface) exist on the front surface of the array plate 1. It should be noted that it is sufficient for the first region 1a and the second region 1b to exist on the front surface of the array plate 1, and the shape of the frame 5 is not limited. For example, as illustrated in FIG. 2B-1, the frame 5 in the shape of a rectangle, approximately the same size as the region 4 (refer to FIG. 2A), may be used, with the inside and outside of the frame 5 defined as the second region 1b and the first region 1a, respectively. Further, as illustrated in FIG. 2B-2, the first region 1a may be positioned within the second region 1b. Further, as illustrated in FIG. 2B-3, the shape of the frame 5 is not limited to a rectangle; for example, the first region 1a may extend into the second region 1b.

FIGS. 2B-4 and 2B-5 are diagrams illustrating the array plate 1 viewed from the X-direction. Retaining the observation liquid 6 inside the frame 5 as illustrated in FIG. 2B-4 is a typical example. Further, as illustrated in FIG. 2B-5, the array plate 1 may be placed in the observation liquid 6, and the frame 5 in the shape of a cup may be used to secure the first region 1a.

It should be noted that the solid-liquid interface corresponds to an interface where a solid and a gas with a difference in refractive index n (n_solid>n_gas) are in contact, and is an interface where reflected light corresponding to the refractive index difference of the interface is obtained. As the gas forming the solid-gas interface, an ambient gas from an environment where an optical system for fluorescence measurement is placed is used, and atmospheric air at 1 atm, a specified partial pressure of nitrogen or diluted nitrogen, carbon dioxide, and oxygen are included. The solid forming the solid-gas interface includes the array plate 1 with a higher refractive index than that of the gas with which the solid is in contact, and a thin film on the array plate 1.

Further, the solid-liquid interface corresponds to an interface where a solid and a liquid with a small difference in refractive index n (n_solid≈n_liquid) are in contact, and is an interface where it is difficult to obtain the light intensity of the reflected light corresponding to the refractive index difference of the interface. The liquid forming the solid-liquid interface includes the observation liquid, such as a buffer solution or a purge liquid, that is applied to or remains on the array plate 1 during fluorescence measurement. The solid forming the solid-liquid interface includes the array plate and a thin film on the array plate 1. The thin film on the array plate 1 includes the spots 3 where the biomolecules such as proteins or peptides are immobilized.

Further, a value sufficiently smaller than the depth of focus determined by the numerical aperture of an objective optical system is generally used for the thickness of each spot on the array plate when considering the solid-liquid interface. In other words, an objective lens with a specification that allows the depth of focus sufficiently larger than the thickness of each spot on the array plate to overlap in the optical axis is used for measurement. The depth of focus DOF, which depends on the numerical aperture NA and the wavelength 2 of light, can be determined using the Berek formula.

In step S2, first position information about the interface position of the solid-gas interface in the first region 1a is optically acquired.

This step acquires the first position information by irradiating the array plate 1 with focused light from a confocal optical system. As the first position information, information about the position of the solid-gas interface in the first region 1a in the Z-direction, i.e., the position of the front surface of the array plate 1 in the first region 1a in the Z-direction, is acquired. It should be noted that the positions in the X-, Y-, and Z-directions will be referred to as the X-, Y-, and Z-positions, respectively. The Z-position of the solid-gas interface in the first region 1a can be detected by irradiating with focused light while changing the irradiation position in the Z-direction and detecting the peak of the reflected light intensity. Details of step S2 will be described in each embodiment described below.

In step S3, second position information about the interface position of the solid-liquid interface in the second region 1b is acquired based on the first position information acquired in step S2.

In this step, information about the Z-position of the solid-liquid interface in the second region 1b, which is brought into contact with the observation liquid 6 and is difficult to detect optically, i.e., information about the Z-position of the front surface of the array plate 1 in the second region 1b, is acquired as the second position information. Here, an equation expressed as a straight line or curve to calculate the Z-position of the solid-liquid interface in the second region 1b is set. Details of step S3 will be described in each embodiment described below.

It should be noted that while the step of setting the equation for calculating the interface position of the solid-liquid interface in the second region 1b based on the first position information is described as being included in step S3, this is not a limitation. Instead of or in addition to the step of setting the equation, a step of making a determination related to focusing on the solid-liquid interface based on the first position information and/or a step of referring to prior information about the interface position of the solid-liquid interface may be included.

In step S4, position adjustment information about position adjustment within a scanning range of the second region 1b is acquired based on the second position information acquired in step S3.

In this step, the change in Z-position of the solid-liquid interface within the scanning range of the second region 1b in the Y-direction is detected based on the second position information (the equation for calculating the Z-position of the solid-liquid interface in the second region 1b) acquired in step S3, and a Z-position adjustment amount is calculated as position adjustment information. Step S4 will be described in each embodiment described below.

Steps S2 to S4 constitute a pre-scan, followed by a main scan (main scanning) performed in step S5. In the main scan, the confocal optical system irradiates the array plate 1 with focused light based on the position adjustment information acquired in step S4 to scan the second region 1b optically and three-dimensionally and acquire optical information about a target.

The main scan includes a scanning step of forming an irradiation spot in the second region 1b by irradiating the second region 1b with primary light including focused light and moving the irradiation spot relative to the array plate 1. In the scanning step, a focusing step of adjusting a depth reference position (focal position) of a depth of focus relative to the solid-liquid interface in the optical axis direction of the primary light based on the position adjustment information is included. The focusing step is performed by at least one of adjusting a working distance between the array plate 1 and an emission end of the primary light and adjusting a focal length of an objective optical system including the emission end. The scanning step is performed at the depth reference position adjusted by the focusing step.

As described above, in a case where the front surface of the array plate 1 is brought into contact with the observation liquid 6, the position of the front surface of the second region 1b that is brought into contact with the observation liquid 6 is identified based on the first position information acquired from the first region 1a, which is brought into contact with air, enabling precise scanning.

Specific examples of a scanning method and a scanning system to which the present invention is applied will be described below.

### First Embodiment

FIGS. 3A and 3B are diagrams illustrating a schematic configuration of a scanning system according to a first embodiment. FIG. 3A is a diagram illustrating a schematic configuration of the scanning system, and FIG. 3B is a diagram illustrating a functional configuration of an information processing apparatus 400. The scanning system according to the first embodiment is a fluorescence-based confocal scanning system.

The scanning system includes a support portion 100 configured to support the array plate 1, a Y-direction (sub-scanning direction) scanning mechanism 150, and a height adjustment mechanism 160 configured to adjust the position in the Z-direction (height direction).

The array plate 1 is as described above, and a biomolecule containing a peptide bond is immobilized at each spot 3 on the slide glass as the substrate 2. A single type of biomolecule is immobilized at each spot. In addition, fluorescent labeling responsive to the characteristics and state of the immobilized biomolecule is applied to the spots 3. The surface of the array plate 1 is divided into the first region 1a, which is brought into contact with air, and the second region 1b, which is brought into contact with the observation liquid 6. The array plate 1 as described above is placed on the support portion 100 and thereby being supported and is arranged to bring air into contact with the first region 1a and bring the observation liquid 6 into contact with the second region 1b. The support portion 100 is connected to the Y-direction scanning mechanism 150, which corresponds to the sub-scanning direction, and the height adjustment mechanism 160 for adjusting the Z-position, which corresponds to the height position, and can be moved in the Y- and Z-directions. The scanning mechanism 150 and the height adjustment mechanism 160 are scanning units configured to optically scan the array plate 1 by changing a relative position between the array plate 1 and primary light irradiated by an observation optical system 200.

Further, the scanning system includes the observation optical system 200, which is a confocal optical system. The observation optical system 200 is an optical system configured to irradiate the spots 3 with primary light and collect secondary light.

The observation optical system 200 includes a semiconductor laser 201, a collimating lens 202, a band-pass filter 203, a polarizing beam splitter 204, a λ/4 wave plate 205, a long-pass filter 206, an objective lens 207, and a one-dimensional scanning mechanism 208. The semiconductor laser 201 emits light having wavelength of 670 nm. The band-pass filter 203 is a filter that transmits light having wavelengths near 670 nm. The long-pass filter 206 is a long-pass filter with a cut-on wavelength of 685 nm. The λ/4 wave plate 205 is a λ/4 wave plate with its slow axis tilted at 45 degrees relative to the polarization direction of the polarizing beam splitter 204.

Light emitted from the semiconductor laser 201 passes through the collimating lens 202, the band-pass filter 203, and the polarizing beam splitter 204 and becomes circularly polarized upon passing through the λ/4 wave plate 205. The light that passes through the λ/4 wave plate 205 is reflected by the long-pass filter 206 and focused onto the front surface of the array plate 1 by the objective lens 207. The configuration that irradiates focused light through the back surface of the array plate 1 as described above is employed.

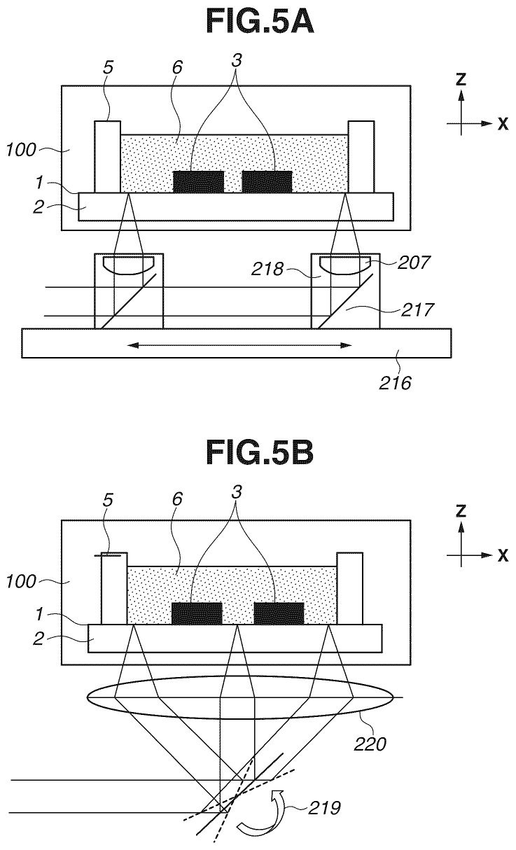

The one-dimensional scanning mechanism 208 is a mechanism for performing main scanning (scanning in the X-direction). An example of a configuration of the one-dimensional scanning mechanism 208 will be described below with reference to FIGS. 5A and 5B. The one-dimensional scanning mechanism 208 is preferably configured to scan at high speed to reduce measurement time. For example, as illustrated in FIG. 5A, the one-dimensional scanning mechanism 208 is composed of a unit 218 placed on a linear guide 216 parallel to the X-direction, the unit 218 including a combination of the objective lens 207 and a mirror 217 positioned at a 45-degree angle relative to the linear guide 216. By moving the unit 218 along the linear guide 216, it becomes possible to scan the focused irradiation light in the X-direction. The unit 218 is composed of, for example, a piston-crank mechanism that converts the rotational motion of an electric actuator or motor into a linear motion.

Further, as illustrated in FIG. 5B, the one-dimensional scanning mechanism 208 may be composed of a combination of a galvanometer scanner 219 and a focusing lens 220. As the focusing lens 220, a telecentric lens or a fθ lens can be used.

Returning to the description with reference to FIGS. 3A and 3B, the observation optical system 200 includes a band-pass filter 211, a fluorescence imaging lens 209, a pinhole 210, and a photomultiplier tube 213. The band-pass filter 211 is a filter that transmits light having wavelengths near 716 nm.

Fluorescence emitted from the spots 3 of the array plate 1 passes through the objective lens 207 and the long-pass filter 206 and is focused by the imaging lens 209, and light that passes through the pinhole 210 is detected by the photomultiplier tube 213.

Further, the observation optical system 200 includes an imaging lens 214 for reflected light, a pinhole 215, and a light detecting device 212.

Excitation light reflected by the substrate 2 of the array plate 1 passes through the objective lens 207 and is reflected by the long-pass filter 206. Since the direction of the circular polarization of the reflected light is reversed due to the reflection on the substrate 2, the light passing through the λ/4 wave plate 205 is in a state rotated by 90 degrees from the linear polarization of the irradiated light and reflected by the polarizing beam splitter 204. The light reflected by the polarizing beam splitter 204 is focused by the imaging lens 214, and the light that passes through the pinhole 215 is detected by the light detecting device 212.

The observation optical system 200 configured as described above is capable of separating fluorescence and reflected light and acquiring them simultaneously. Here, adjustments are made so that the excitation light spot focused by the objective lens 207 and the pinholes 210 and 215 are in a confocal relationship. In this case, when the intensity of the reflected light from the array plate 1 detected by the light detecting device 212 reaches its maximum, the fluorescence intensity detected by the photomultiplier tube 213 also reaches its maximum. Further, even in a case where there is a deviation from the confocal relationship, by measuring the deviation amount in advance and storing it as an offset value, the position where the fluorescence intensity reaches its maximum can be determined based on the position where the reflected light intensity is at its maximum.

Further, the scanning system includes the information processing apparatus 400. The information processing apparatus 400 controls the driving of the scanning mechanism 150, the height adjustment mechanism 160, and the one-dimensional scanning mechanism 208 and performs the pre-scan and the main scan described above. Reflected light information from the array plate 1 detected during the pre-scan is stored in a storage medium 450.

As illustrated in FIG. 3B, the information processing apparatus 400 includes a first position information acquisition unit 401, a second position information acquisition unit 402, and a position adjustment information acquisition unit 403. The information processing apparatus 400 is composed of, for example, a computer apparatus that includes a CPU, a ROM, and a RAM, and the CPU executes a predetermined program stored in, for example, the ROM to execute a function of the units 401 to 403.

A scanning method according to the first embodiment will be described below with reference to the flowchart in FIG. 1.

The present embodiment applies to a case where there is variability in the array plates 1 and variation in the thickness of the substrate 2 among the array plates 1. More specifically, it applies to a case where, when the array plate 1 is replaced, the difference in surface height (difference in Z-position) of the array plate 1 caused by the variation in thickness of the substrate 2 may not fall within the depth of focus. On the other hand, it is assumed that there are neither a thickness variation in a single array plate 1 nor a tilt in the array plate 1 placed on the support portion 100. More specifically, it applies to a case where the difference in surface height of the array plate 1 caused by the variation in thickness of a single array plate 1 or a tilt in the array plate 1 falls within the depth of focus.

In step S1, the array plate 1 is placed on the support portion 100 and arranged to bring air into contact with the first region 1a and bring the observation liquid 6 into contact with the second region 1b.

In step S2, the first position information acquisition unit 401 optically acquires the first position information about the interface position of the solid-gas interface in the first region 1a.

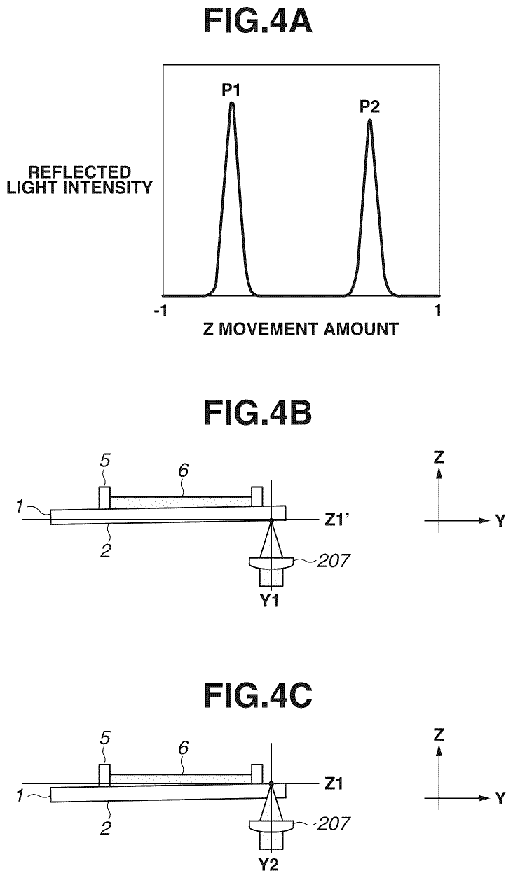

The process of step S2 will be described below with reference to FIGS. 4A, 4B, and 4C. FIGS. 4A, 4B, and 4C are diagrams for describing a process for acquiring the first position information, FIG. 4A being a characteristic diagram illustrating the relationship between the amount of height movement (the amount of movement in the Z-direction) and reflected light intensity, FIG. 4B being a diagram illustrating the state where light is focused on the back surface of the array plate 1, and FIG. 4C being a diagram illustrating the state where light is focused on the front surface of the array plate 1. It should be noted that the illustration of the spots 3 is omitted in FIGS. 4B and 4C.

The information processing apparatus 400 controls the scanning mechanism 150 and positions the objective lens 207 at a Y-position Y1 below the first region 1a of the array plate 1. By controlling the height adjustment mechanism 160 at the Y-position Y1 and irradiating with focused light while changing the irradiation position in the Z-direction, a reflected light profile illustrated in FIG. 4A is obtained. When excitation light is focused on the back surface (Z-position Z1′) of the array plate 1, a peak P1 in the reflected light intensity appears. Thereafter, when excitation light is focused on the front surface of the array plate 1 (Z-position Z1), a peak P2 in the reflected light intensity appears. The first position information acquisition unit 401 records the Z-position Z1 at which the peak P2 in the reflected light intensity appears, as the Z-position of the solid-gas interface in the first region 1a.

In step S3, the second position information acquisition unit 402 acquires the second position information about the interface position of the solid-liquid interface in the second region 1b based on the first position information acquired in step S2.

In the present embodiment, the second position information acquisition unit 402 determines that the Z-position Z of the solid-liquid interface in the second region 1b is Z1, based on the Z-position Z1 acquired as the first position information, regardless of the Y-position. This can be expressed as the equation Z=Z1.

In step S4, the position adjustment information acquisition unit 403 acquires position adjustment information about position adjustment within the scanning range of the second region 1b based on the second position information acquired in step S3.

In the present embodiment, the position adjustment information acquisition unit 403 acquires Z-position adjustment information such as the scanning of the irradiation position in the Z-direction as Z1 within the scanning range of the second region 1b in the Y-direction.

It should be noted that in a case where there is a known offset between the equation set in step S3 and the relative position between the array plate 1 and the observation optical system 200, the Z-position Z of the solid-liquid interface in the second region 1b is determined as Z=Z1+A using an offset value A.

As described above, the position adjustment information for relatively moving the array plate 1 and the observation optical system 200 can be acquired.

In step S5, the information processing apparatus 400 performs a main scan. The information processing apparatus 400 adjusts the relative position between the array plate 1 and the observation optical system 200 by simultaneously controlling the scanning mechanism 150 and the height adjustment mechanism 160, either through step control or constant speed control, based on the position adjustment information acquired in step S4. By combining this with the main scanning performed by the one-dimensional scanning mechanism 208, the main scan is performed, allowing the acquisition of a focused fluorescence image across the entire measurement region. In the case of the present embodiment, since the Z-position is maintained as constant (Z-position Z1) within the scanning range of the second region 1b, the height adjustment mechanism 160 remains stationary without operating during the main scan.

As described above, the main scan is performed after the Z-position of the front surface of the second region 1b is identified. In the present embodiment, even in a case where there is variability in the array plates 1 and variation in the thickness of the substrate 2 among the array plates 1, a fluorescence image can be acquired by aligning the focal point position without causing a decrease in fluorescence intensity, enabling accurate scanning thereby.

It should be noted that, while the present embodiment describes an example of a configuration in which the scanning mechanism 150 and the height adjustment mechanism 160 are connected to the support portion 100, this is not a limitation, and any configuration capable of adjusting the relative position between the array plate 1 and the observation optical system 200 can be used.

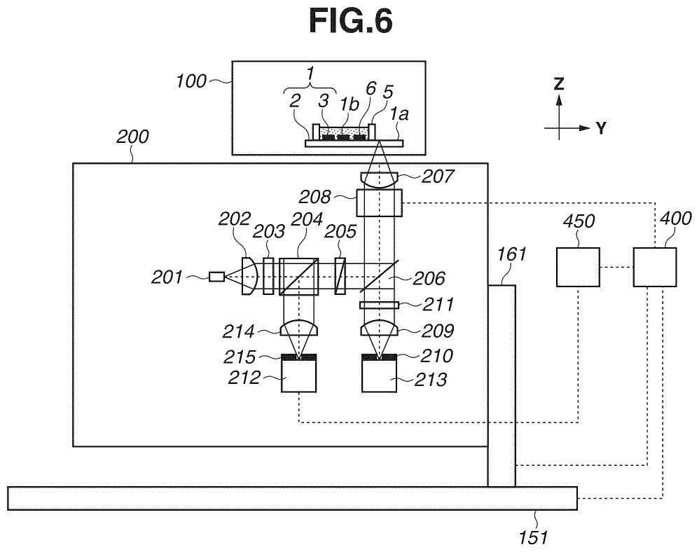

As illustrated in FIG. 6, a scanning mechanism 151 and a height adjustment mechanism 161 may be connected to the observation optical system 200.

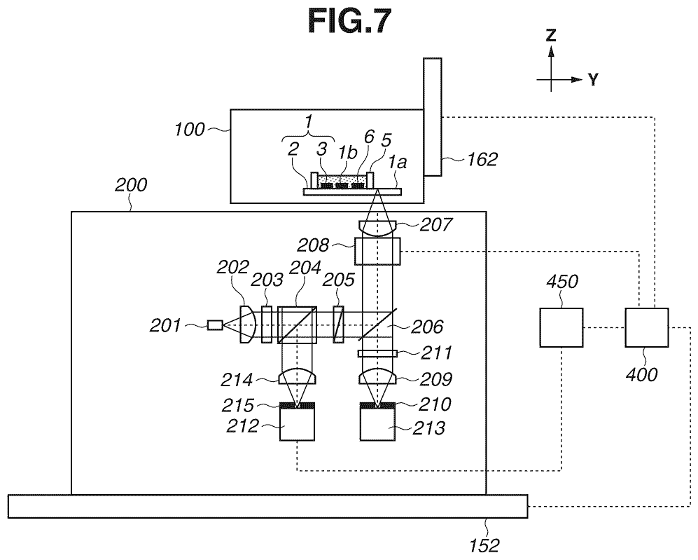

Further, as illustrated in FIG. 7, a scanning mechanism 152 may be connected to the observation optical system 200, and a height adjustment mechanism 162 may be connected to the support portion 100.

### Second Embodiment

Next, a second embodiment will be described below. The second embodiment differs from the first embodiment in the processes of steps S2 to S4. A schematic configuration and basic operational processes of a scanning system are similar to those in the first embodiment, and mainly differences from the first embodiment will be described below.

A scanning method according to the second embodiment will be described below with reference to the flowchart in FIG. 1.

The present embodiment applies to a case where there is variability in the array plates 1 and variation in the thickness of the substrate 2 among the array plates 1. More specifically, it applies to a case where, when the array plate 1 is replaced, the difference in surface height (difference in Z-position) of the array plate 1 caused by the variation in thickness of the substrate 2 may not fall within the depth of focus. Further, it applies to a case where the difference in surface height of the array plate 1 caused by the variation in thickness of a single array plate 1 in the Y-direction or a tilt in the array plate 1 placed on the support portion 100 in the Y-direction may not fall within the depth of focus.

In step S2, the first position information acquisition unit 401 optically acquires the first position information about the interface position of the solid-gas interface in the first region 1a. In the first embodiment, the first position information is acquired at one Y-position. On the other hand, in the present embodiment, the first region 1a exists on both sides of the second region 1b, and the first position information is acquired at the Y-positions on both sides of the second region 1b.

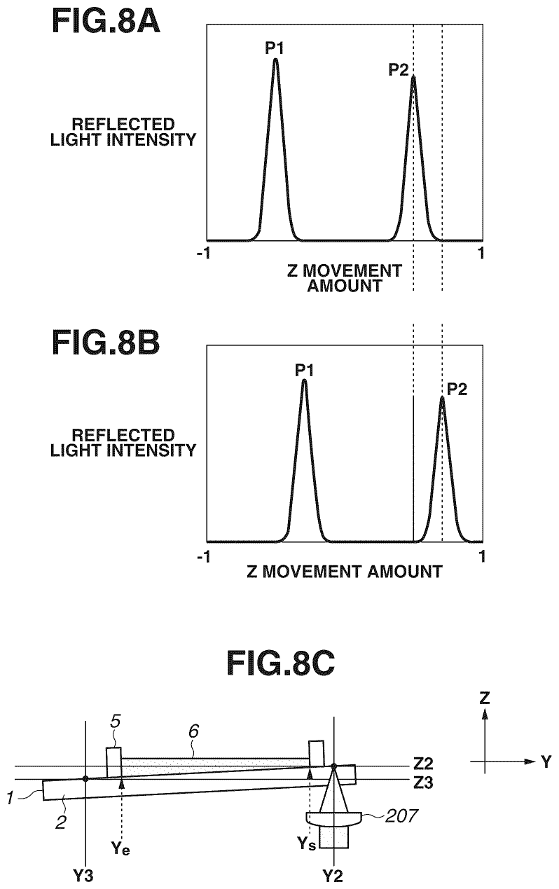

The process of step S2 will be described below with reference to FIGS. 8A, 8B, and 8C. FIGS. 8A, 8B, and 8C are diagrams for describing a process for acquiring the first position information, FIGS. 8A and 8B being characteristic diagrams illustrating the relationship between the amount of height movement (the amount of movement in the Z-direction) and reflected light intensity, and FIG. 8C being a diagram illustrating the state where light is focused on the front surface of the array plate 1. It should be noted that the illustration of the spots 3 is omitted in FIG. 8C.

The information processing apparatus 400 controls the scanning mechanism 150 and positions the objective lens 207 at a Y-position Y2 below the first region 1a of the array plate 1. By controlling the height adjustment mechanism 160 at the Y-position Y2 and irradiating with focused light while changing the irradiation position in the Z-direction, peaks P1 and P2 in the reflection intensity appear as illustrated in FIG. 8A, similarly to those described above with reference to FIGS. 4A, 4B, and 4C. The first position information acquisition unit 401 records a Z-position Z2 at which the peak P2 in the reflected light intensity appears as the Z-position of the solid-gas interface in the first region 1a.

Further, the information processing apparatus 400 controls the scanning mechanism 150 and positions the objective lens 207 at a Y-position Y3 below the first region 1a of the array plate 1. The Y-positions Y2 and Y3 correspond to the Y-positions on both sides of the second region 1b. By controlling the height adjustment mechanism 160 at the Y-position Y3 and irradiating with focused light while changing the irradiation position in the Z-direction, peaks P1 and P2 in the reflection intensity appear as illustrated in FIG. 8A, similarly to those described above with reference to FIGS. 4A, 4B, and 4C. The first position information acquisition unit 401 records a Z-position Z3 at which the peak P2 in the reflected light intensity appears as the Z-position of the solid-gas interface in the first region 1a.

It should be noted that at the Y-position Y2, the Z-position of the solid-gas interface in the first region 1a can be detected at a single X-position, or the Z-position of the solid-gas interface in the first region 1a can be detected at a plurality of X-positions, and then, for example, its average value can be calculated. While the same applies to the Y-position Y3, it is preferable to match the X-position for the Y-position Y3 with the X-position for the Y-position Y2.

In step S3, the second position information acquisition unit 402 acquires the second position information about the interface position of the solid-liquid interface in the second region 1b based on the first position information acquired in step S2.

In the present embodiment, the second position information acquisition unit 402 performs linear interpolation based on the Z-positions Z2 and Z3 at the Y-positions Y2 and Y3 acquired as the first position information, and the Z-position Z of the solid-liquid interface in the second region 1b at a Y-position is expressed by the following equation (1):

$$Z = \{ ( Z 2 - Z 3 ) / ( Y 2 - Y 3 ) \} * ( Y - Y 2 ) + Z 2 , \qquad ( 1 )$$

where (Z2−Z3)/(Y2−Y3) indicates the tilt of the front surface of the array plate 1.

In step S4, the position adjustment information acquisition unit 403 acquires the position adjustment information about position adjustment within the scanning range of the second region 1b based on the second position information acquired in step S3.

In the present embodiment, the position adjustment information acquisition unit 403 calculates Z-positions Zs and Ze at end positions Ys and Ye within the scanning range of the second region 1b in the Y-direction by using the equation (1). As described above, since the Z-position of the solid-liquid interface in the second region 1b changes from Zs to Ze within the scanning range of the second region 1b in the Y-direction, the position adjustment information acquisition unit 403 acquires the Z-position adjustment information such as the scanning to be performed by adjusting the irradiation position in the Z-direction from Zs to Ze within the scanning range of the second region 1b in the Y-direction.

As described above, the main scan is performed after the Z-position of the front surface of the second region 1b is identified. In the present embodiment, even in a case where there is variability in the array plates 1 and variation in the thickness of the substrate 2 among the array plates 1 and a case where there is a thickness variation in a single array plate 1 in the Y-direction or a tilt in the array plate 1 in the Y-direction, a fluorescence image can be acquired by aligning the focal point position without causing a decrease in fluorescence intensity, enabling accurate scanning thereby.

While the first position information is acquired at two points in the first region 1a and the second position information is acquired by linear interpolation, this is not a limitation. The first position information may be acquired at three or more points in the first region 1a, and the second position information may be acquired by fitting a higher-order function.

### Third Embodiment

Next, a third embodiment will be described below. The third embodiment differs from the first embodiment in the processes of steps S2 to S4. A schematic configuration and basic operational processes of a scanning system are similar to those in the first embodiment, and mainly differences from the first embodiment will be described below.

A scanning method according to the third embodiment will be described below with reference to the flowchart in FIG. 1.

The present embodiment applies to a case where there is variability in the array plates 1 and variation in the thickness of the substrate 2 among the array plates 1. More specifically, it applies to a case where, when the array plate 1 is replaced, the difference in surface height (difference in Z-position) of the array plate 1 caused by the variation in thickness of the substrate 2 may not fall within the depth of focus. Further, it applies to a case where the difference in surface height of the array plate 1 caused by tilt in the array plate 1 placed on the support portion 100 in the Y-direction may not fall within the depth of focus. On the other hand, it is assumed that there are no variations in thickness of a single array plate 1. More specifically, it applies to a case where the difference in surface height of the array plate 1 caused by the variation in thickness of a single array plate 1 in the Y-direction falls within the depth of focus.

In step S2, the first position information acquisition unit 401 optically acquires the first position information about the interface position of the solid-gas interface in the first region 1a. Further, the first position information acquisition unit 401 optically acquires third position information about the position of the back surface of the array plate 1, in addition to the first position information.

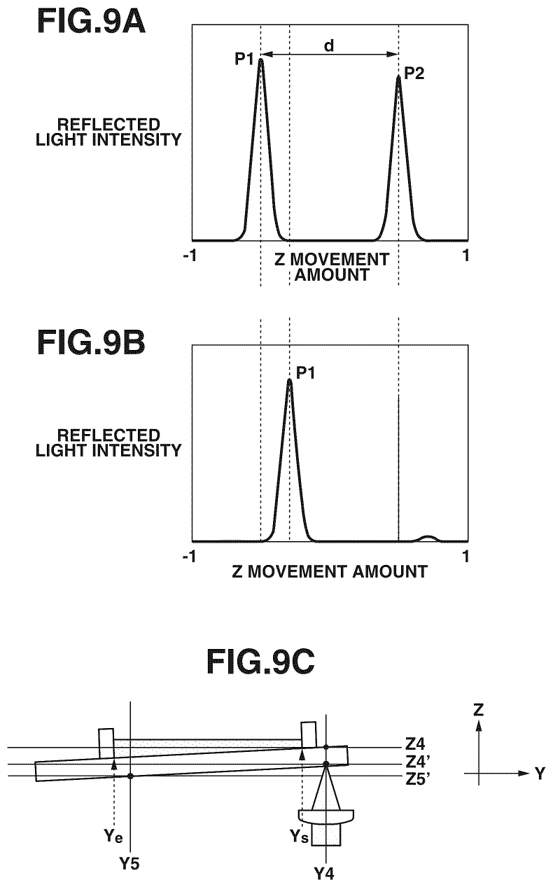

The process of step S2 will be described below with reference to FIGS. 9A, 9B, and 9C. FIGS. 9A, 9B, and 9C are diagrams for describing a process for acquiring the first position information and the third position information, FIGS. 9A and 9B being characteristic diagrams illustrating the relationship between the amount of height movement (the amount of movement in the Z-direction) and reflected light intensity and FIG. 9C being a diagram illustrating the state where light is focused on the back surface of the array plate 1. It should be noted that the illustration of the spots 3 is omitted in FIG. 9C.

The information processing apparatus 400 controls the scanning mechanism 150 and positions the objective lens 207 at a Y-position Y4 below the first region 1a of the array plate 1. By controlling the height adjustment mechanism 160 at the Y-position Y4 and irradiating with focused light while changing the irradiation position in the Z-direction, peaks P1 and P2 in the reflection intensity appear as illustrated in FIG. 9A, similarly to those described above with reference to FIGS. 4A, 4B, and 4C. The first position information acquisition unit 401 records a Z-position Z4′ at which the peak P1 in the reflected light intensity appears as the Z-position of the back surface of the first region 1a, and records a Z-position Z4 at which the peak P2 in the reflected light intensity appears as the Z-position of the solid-gas interface in the first region 1a.

Further, the information processing apparatus 400 controls the scanning mechanism 150 and positions the objective lens 207 at a Y-position Y5 below the second region 1b of the array plate 1. By controlling the height adjustment mechanism 160 at the Y-position Y5 and irradiating with focused light while changing the irradiation position in the Z-direction, a peak P1 in the reflection intensity due to reflection on the back surface appears as illustrated in FIG. 9B, similarly to those described above with reference to FIGS. 4A, 4B, and 4C. However, a peak P2 due to reflection on the front surface in contact with the observation liquid does not appear (or is significantly small). The first position information acquisition unit 401 records a Z-position Z5′ at which the peak P1 in the reflected light intensity appears as the Z-position of the back surface of the second region 1b.

It should be noted that at the Y-position Y4, the Z-positions of the back surface of the first region 1a and the solid-gas interface can be detected at a single X-position, or the Z-positions of the back surface of the first region 1a and the solid-gas interface can be detected at a plurality of X-positions, and then, for example, its average value can be calculated. While the same applies to the Y-position Y5, it is preferable to match the X-position for the Y-position Y5 with the X-position for the Y-position Y4.

In step S3, the second position information acquisition unit 402 acquires the second position information about the interface position of the solid-liquid interface in the second region 1b based on the first position information and the third position information acquired in step S2.

As illustrated in FIGS. 9A, 9B, and 9C, a difference d between the Z-positions Z4′ and Z4 at which the peaks P1 and P2 respectively appear at the Y-position Y4 becomes thickness information corresponding to the thickness of the array plate 1. It should be noted that the thickness information differs from the actual thickness because it includes refractive index information about the substrate 2 used in the array plate 1. At the Y-position Y5, the Z-position of the back surface of the second region 1b is obtained. Since the difference in surface height of the array plate 1 caused by the variation in thickness of a single array plate 1 in the Y-direction falls within the depth of focus, the Z-position Z5 of the front surface of the second region 1b at the Y-position Y5 can be calculated using the following equation (2)

$$Z 5 = Z 5 ’ + d . \qquad ( 2 )$$

The second position information acquisition unit 402 performs linear interpolation based on the Z-positions Z4 and Z5 at the Y-positions Y4 and Y5, and the Z-position Z of the solid-liquid interface in the second region 1b at a Y-position is expressed by the following equation (3):

$$Z = \{ ( Z 4 - Z 5 ) / ( Y 4 - Y 5 ) \} * ( Y - Y 4 ) + Z 4 , \qquad ( 3 )$$

where (Z4−Z5)/(Y4−Y5) indicates the tilt of the front surface of the array plate 1.

In step S4, the position adjustment information acquisition unit 403 acquires the position adjustment information about position adjustment within the scanning range of the second region 1b based on the second position information acquired in step S3.

In the present embodiment, as in the second embodiment, the position adjustment information acquisition unit 403 calculates the Z-positions Zs and Ze at the end positions Ys and Ye within the scanning range of the second region 1b in the Y-direction by using the equation (3). As described above, since the Z-position of the solid-liquid interface in the second region 1b changes from Zs to Ze within the scanning range of the second region 1b in the Y-direction, the position adjustment information acquisition unit 403 acquires the Z-position adjustment information such as the scanning to be performed by adjusting the irradiation position in the Z-direction from Zs to Ze within the scanning range of the second region 1b in the Y-direction.

As described above, the main scan is performed after the Z-position of the front surface of the second region 1b is identified. In the present embodiment, even in a case where there is variability in the array plates 1 and variation in the thickness of the substrate 2 among the array plates 1 and in a case where there is a tilt in the array plate 1 in the Y-direction, a fluorescence image can be acquired by aligning the focal point position without causing a decrease in fluorescence intensity, enabling accurate scanning thereby. Further, since the Z-position in the second region 1b, which is an image acquisition region, is used as a reference, the accuracy of the position adjustment information is improved.

It should be noted that the second position information may be acquired by fitting a higher-order function instead of linear interpolation, as described above in the second embodiment.

### Fourth Embodiment

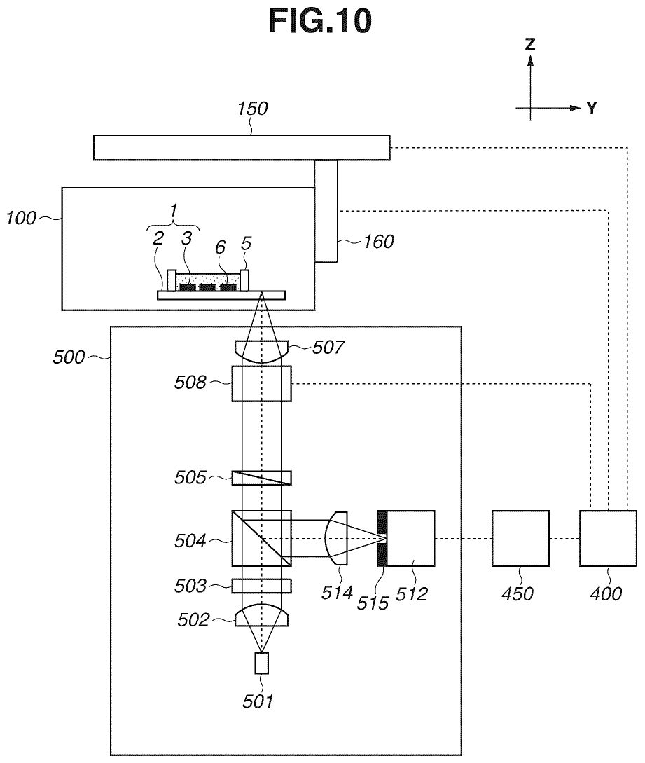

Next, a fourth embodiment will be described below with reference to FIG. 10. The fourth embodiment describes a reflective confocal scanning system.

FIG. 10 illustrates a schematic configuration of the scanning system according to the fourth embodiment. It should be noted that components similar to those of the scanning system according to the first embodiment are assigned the same reference numbers, and their descriptions are omitted. In the fluorescence-based confocal scanning system, fluorescence from the spots is detected, whereas in the reflective confocal scanning system, light reflected from the spots is detected.

The reflective confocal scanning system includes an observation optical system 500, which is a confocal optical system.

The observation optical system 500 includes a semiconductor laser 501, a collimating lens 502, a band-pass filter 503, a polarizing beam splitter 504, a λ/4 wave plate 505, an objective lens 507, and a one-dimensional scanning mechanism 508. The semiconductor laser 501 emits light having wavelength of 670 nm. The band-pass filter 503 is a filter that transmits light having wavelengths near 670 nm.

Light emitted from the semiconductor laser 501 passes through the collimating lens 502, the band-pass filter 503, and the polarizing beam splitter 504. The light that passes through the λ/4 wave plate 505 is focused onto the front surface of the array plate 1 by the objective lens 507. The configuration that irradiates focused light through the back surface of the array plate 1 as described above is employed.

The one-dimensional scanning mechanism 508 is a mechanism for performing main scanning in the X-direction and similar to the one-dimensional scanning mechanism 208.

Further, the observation optical system 500 includes an imaging lens 514 for reflected light, a pinhole 515, and a light detecting device 512.

Reflected light from the spots 3 of the array plate 1 passes through the objective lens 507 and the λ/4 wave plate 505 and is reflected by the polarizing beam splitter 504. The light reflected by the polarizing beam splitter 504 is focused by the imaging lens 514, and the light that passes through the pinhole 515 is detected by the light detecting device 512.

In the observation optical system 500 configured as described above, the light detecting device 512 has two roles, which are detecting the position of the array plate 1 and acquiring a two-dimensional image based on the reflected light from the spots 3, making it possible to obtain optical information about the spots 3 with a simpler configuration. Further, since the observation liquid 6 in contact with the front surface of the array plate 1 has a refractive index close to that of the array plate 1, compared to air, light emitted from the optical system is less likely to be reflected at the interface between the array plate 1 and the observation liquid 6, making it possible to obtain optical information with a higher signal-to-noise ratio.

It should be noted that while the λ/4 wave plate 505 and the polarizing beam splitter 504 are used to guide reflected light to the light detecting device 512 in the present embodiment, this is not a limitation.

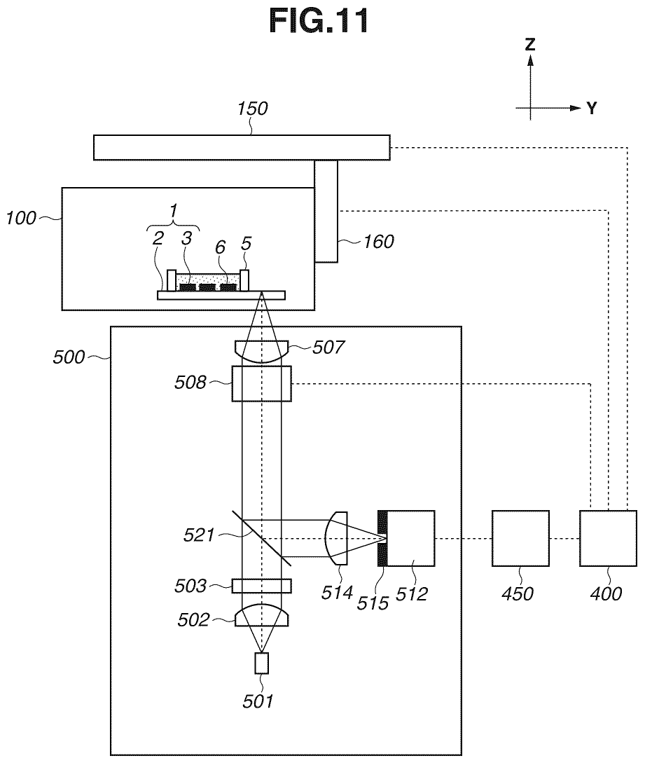

As illustrated in FIG. 11, a half mirror 521 may be used to guide reflected light to the light detecting device 512. With this configuration, the acquisition of a two-dimensional image based on the reflected light from the spots 3 of the array plate 1 by the light detecting device 512 can be achieved with a simpler configuration.

### Fifth Embodiment

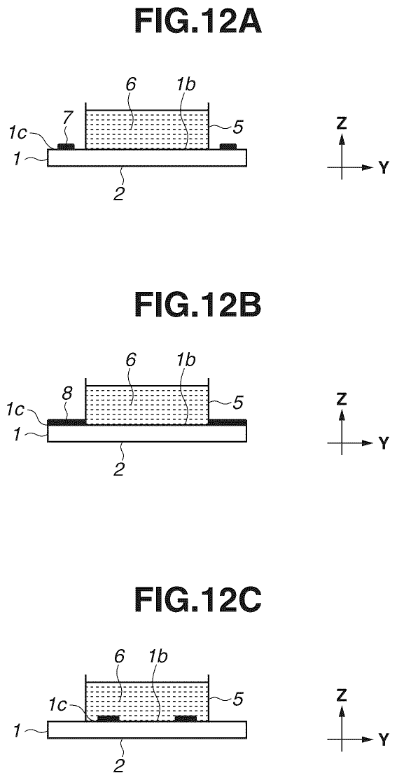

Next, a fifth embodiment will be described below with reference to FIGS. 12A, 12B, and 12C. The fifth embodiment describes modified examples of a first region in the array plate 1. FIGS. 12A, 12B, and 12C are diagrams illustrating the modified examples of the first region in the array plate 1.

While the first region 1a with the solid-gas interface (substrate/air interface) exists on the front surface of the array plate 1 in FIGS. 2B-1 to 2B-5, this is not a limitation. The present invention is also applicable to a case where a first region 1c with a solid-solid interface (substrate/solid interface) exists as illustrated in FIGS. 12A, 12B, and 12C.

For example, as illustrated in FIG. 12A, a reflective film 7 such as a dielectric multilayer film or a metal film is provided on the front surface of the array plate 1. In this case, a solid-solid interface is formed between the array plate 1 and the reflective film 7 in the first region 1c. To improve measurement accuracy, the reflectivity of the reflective film 7 is preferably higher than that of the solid-gas interface, and the reflectivity is preferably 10% or higher.

Further, as illustrated in FIG. 12B, a resin coating film 8 is provided on the front surface of the array plate 1 to prevent measurement errors caused by dirt. In this case, a solid-solid interface is formed between the array plate 1 and the resin coating film 8 in the first region 1c. A resin coating film 8 having a large refractive index difference from the array plate 1 is preferable, and a resin coating film 8 having a refractive index difference of 0.1 or more from the array plate 1 is preferable.

Further, as illustrated in FIG. 12C, a solid-solid interface may be positioned within the region of the observation liquid 6 or a buffer solution. In this case, the first region 1c is positioned within a part of the second region 1b, but the present invention is still applicable.

It should be noted that the solid-solid interface formed in the first region 1c includes an interface at which the front surface of the array plate 1 and a solid material in contact with, deposited on, or formed on the front surface of the array plate 1 are in contact.

While the present invention has been described along with its embodiments, the embodiments described above merely illustrate examples of embodiments for implementing the present invention, and these should not be interpreted as limiting the technical scope of the present invention. In other words, the present invention can be implemented in various forms without deviating from its technical concept or main features.

### Other Embodiments

The present invention can also be realized by a process in which a program for realizing one or more functions of the embodiments described above is supplied to a system or an apparatus via a network or a storage medium and one or more processors of a computer of the system or the apparatus read the program and execute the read program. Further, the present invention can also be realized by a circuit (e.g., ASIC) configured to realize the one or more functions.

The disclosure of the present embodiment includes the following methods.

### (Method 1)

A scanning method for optically scanning an array plate including a plurality of spots on its front surface, the scanning method including an interface-forming step of forming at least one of a solid-gas interface and a solid-solid interface in a first region of the front surface of the plate by bringing a gas or a solid into contact with the first region and forming a solid-liquid interface in a second region of the front surface of the plate by bringing a liquid into contact with the second region where the plurality of spots is included, a step of optically acquiring first position information about an interface position of at least one of the solid-gas interface and the solid-solid interface, and a step of acquiring second position information about an interface position of the solid-liquid interface based on the first position information.

### (Method 2)

The scanning method according to method 1, further including a scanning step of forming an irradiation spot in the second region by irradiating the second region with primary light including focused light and moving the irradiation spot relative to the array plate.

### (Method 3)

The scanning method according to method 2, further including a focusing step of adjusting a depth reference position of a depth of focus relative to the solid-liquid interface in an optical axis direction of the primary light based on the second position information.

### (Method 4)

The scanning method according to method 3, wherein the scanning step is performed at the depth reference position adjusted by the focusing step.

### (Method 5)

The scanning method according to method 3 or 4, wherein the focusing step is performed by at least one of adjusting a working distance between the array plate and an emission end of the primary light and adjusting a focal length of an objective optical system including the emission end.

### (Method 6)

The scanning method according to any one of methods 1 to 5, wherein the first region does not include a region that overlaps with the plurality of spots.

### (Method 7)

The scanning method according to any one of methods 2 to 5, wherein the primary light is irradiated by a confocal optical system.

### (Method 8)

The scanning method according to any one of methods 1 to 7, wherein the step of optically acquiring the first position information optically acquires the first position information about the interface position of one of the solid-gas interface and the solid-solid interface.

### (Method 9)

The scanning method according to any one of methods 1 to 8, wherein the step of acquiring the second position information includes at least one of a step of setting an equation for calculating the interface position of the solid-liquid interface based on the first position information, a step of making a determination related to focusing on the solid-liquid interface, and a step of referring to prior information.

### (Method 10)

The scanning method according to any one of methods 1 to 9, wherein the solid-gas interface includes an interface at which the front surface of the plate and ambient gas are in contact, and wherein the solid-solid interface includes an interface at which the front surface of the plate and a solid material in contact with, deposited on, or formed on the front surface of the plate are in contact.

### (Method 11)

The scanning method according to any one of methods 1 to 10, wherein the step of acquiring the second position information sets, as the second position information, the equation for calculating the interface position of the solid-liquid interface.

### (Method 12)

The scanning method according to any one of methods 1 to 11, further including a step of acquiring position adjustment information about position adjustment within a scanning range of the second region based on the second position information.

### (Method 13)

The scanning method according to method 12, wherein main scanning is performed to optically scan the second region based on the position adjustment information.

### (Method 14)

The scanning method according to method 13, wherein the main scanning optically scans the second region by irradiating the array plate with focused light using a confocal optical system.

### (Method 15)

The scanning method according to any one of methods 1 to 14, wherein the step of acquiring the first position information acquires the first position information by irradiating the array plate with focused light using a confocal optical system.

### (Method 16)

The scanning method according to any one of methods 1 to 15, wherein the step of acquiring the first position information acquires, as the first position information, information about a position of at least one of the solid-gas interface and the solid-solid interface in a direction perpendicular to a plane including a main scanning direction and a sub-scanning direction of the array plate.

### (Method 17)

The scanning method according to method 16, wherein the step of acquiring the second position information acquires, as the second position information, information about a position of the solid-liquid interface in the perpendicular direction.

### (Method 18)

The scanning method according to method 17, further including a step of acquiring position adjustment information about position adjustment in the perpendicular direction within a scanning range of the second region based on the second position information.

### (Method 19)

The scanning method according to any one of methods 1 to 18, wherein the step of acquiring the first position information acquires the first position information at two or more points in the first region.

### (Method 20)

The scanning method according to method 19, wherein the first region exists on both sides of the second region, and the first position information is acquired at positions on both sides of the second region.

### (Method 21)

The scanning method according to any one of methods 1 to 20, wherein the step of acquiring the first position information optically acquires, in addition to the first position information, third position information about a position of a back surface of the array plate.

The present invention is not limited to the embodiments described above, and various changes and modifications are possible without departing from the spirit and scope of the present invention. Therefore, the following claims are attached to disclose the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention enables accurate scanning in a case where the front surface of an array plate is brought into contact with a liquid.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A scanning method for optically scanning an array plate including a plurality of spots on its front surface, the scanning method comprising:
an interface-forming step of forming at least one of a solid-gas interface and a solid-solid interface in a first region of the front surface of the plate by bringing a gas or a solid into contact with the first region and forming a solid-liquid interface in a second region of the front surface of the plate by bringing a liquid into contact with the second region where the plurality of spots is included;
a step of optically acquiring first position information about an interface position of at least one of the solid-gas interface and the solid-solid interface; and
a step of acquiring second position information about an interface position of the solid-liquid interface based on the first position information.

2. The scanning method according to claim 1, further comprising a scanning step of forming an irradiation spot in the second region by irradiating the second region with primary light including focused light and moving the irradiation spot relative to the array plate.

3. The scanning method according to claim 2, further comprising a focusing step of adjusting a depth reference position of a depth of focus relative to the solid-liquid interface in an optical axis direction of the primary light based on the second position information.

4. The scanning method according to claim 3, wherein the scanning step is performed at the depth reference position adjusted by the focusing step.

5. The scanning method according to claim 3, wherein the focusing step is performed by at least one of adjusting a working distance between the array plate and an emission end of the primary light and adjusting a focal length of an objective optical system including the emission end.

6. The scanning method according to claim 1, wherein the first region does not include a region that overlaps with the plurality of spots.

7. The scanning method according to claim 2, wherein the primary light is irradiated by a confocal optical system.

8. The scanning method according to claim 1, wherein the step of optically acquiring the first position information optically acquires the first position information about the interface position of one of the solid-gas interface and the solid-solid interface.

9. The scanning method according to claim 1, wherein the step of acquiring the second position information includes at least one of a step of setting an equation for calculating the interface position of the solid-liquid interface based on the first position information, a step of making a determination related to focusing on the solid-liquid interface, and a step of referring to prior information.

10. The scanning method according to claim 1,
wherein the solid-gas interface includes an interface at which the front surface of the plate and ambient gas are in contact, and
wherein the solid-solid interface includes an interface at which the front surface of the plate and a solid material in contact with, deposited on, or formed on the front surface the plate are in contact.

11. The scanning method according to claim 1, wherein the step of acquiring the second position information sets, as the second position information, the equation for calculating the interface position of the solid-liquid interface.

12. The scanning method according to claim 1, further comprising a step of acquiring position adjustment information about position adjustment within a scanning range of the second region based on the second position information.

13. The scanning method according to claim 12, wherein main scanning is performed to optically scan the second region based on the position adjustment information.

14. The scanning method according to claim 13, wherein the main scanning optically scans the second region by irradiating the array plate with focused light using a confocal optical system.

15. The scanning method according to claim 1, wherein the step of acquiring the first position information acquires the first position information by irradiating the array plate with focused light using a confocal optical system.

16. The scanning method according to claim 1, wherein the step of acquiring the first position information acquires, as the first position information, information about a position of at least one of the solid-gas interface and the solid-solid interface in a direction perpendicular to a plane including a main scanning direction and a sub-scanning direction of the array plate.

17. The scanning method according to claim 16, wherein the step of acquiring the second position information acquires, as the second position information, information about a position of the solid-liquid interface in the perpendicular direction.

18. The scanning method according to claim 17, further comprising a step of acquiring position adjustment information about position adjustment in the perpendicular direction within a scanning range of the second region based on the second position information.

19. The scanning method according to claim 1, wherein the step of acquiring the first position information acquires the first position information at two or more points in the first region.

20. The scanning method according to claim 19, wherein the first region exists on both sides of the second region, and the first position information is acquired at positions on both sides of the second region.

21. The scanning method according to claim 1, wherein the step of acquiring the first position information optically acquires, in addition to the first position information, third position information about a position of a back surface of the array plate.

22. A scanning system for optically scanning an array plate including a plurality of spots on its front surface, the scanning system comprising:
a support portion configured to support the array plate so that at least one of a solid-gas interface and a solid-solid interface is formed in a first region of the front surface of the plate by bringing a gas or a solid into contact with the first region and a solid-liquid interface is formed in a second region of the front surface of the plate by bringing a liquid into contact with the second region where the plurality of spots is included;
an optical system configured to irradiate the spots with primary light and collect secondary light;
a scanning unit configured to optically scan the array plate by changing a relative position between the array plate and the primary light;
a first position information acquisition unit configured to optically acquire first position information about an interface position of at least one of the solid-gas interface and the solid-solid interface; and
a second position information acquisition unit configured to acquire second position information about an interface position of the solid-liquid interface based on the first position information.

23. A position information acquisition method for acquiring information about a position of one surface of an array plate including a plurality of spots on the one surface in a state where at least a portion of the plurality of spots is in contact with a liquid, the position information acquisition method comprising:
an interface-forming step of forming at least one of a solid-gas interface and a solid-solid interface in a first region of the one surface by bringing a gas or a solid into contact with the first region and forming a solid-liquid interface in a second region of the one surface by bringing a liquid into contact with the second region where the plurality of spots is included;
a step of optically acquiring first position information about an interface position of at least one of the solid-gas interface and the solid-solid interface; and
a step of acquiring second position information about an interface position of the solid-liquid interface based on the first position information.
